(19) United States
(12) Patent Application Publication
(10) Pub. No.: US 2015/0262318 A1
(43) Pub. Date: Sep. 17, 2015

(54) Litigation and Court Case History Analysis and Results

(71) Applicant: Element Limited Corp, Orlando, FL (US)

(72) Inventor: Toby Unwin, Orlando, FL (US)

(73) Assignee: Element Limited Corp, Orlando, FL (US)

(21) Appl. No.: 14/216,933

(22) Filed: Mar. 17, 2014

(51) Int. Cl. G06Q 50/18; G06Q 10/06

(52) U.S. Cl. CPC G06Q 50/18; G06Q 10/0639

(57) ABSTRACT

The current invention is a system, method and program that can analyze an attorney or set of attorney's case histories before a certain judge or courts. It then uses this information to produce an easy to understand graphic display. The client can use this display to decide which attorney to use or whether or not to keep their current attorney.

### CROSS-REFERENCE TO RELATED APPLICATIONS (if any)

None

### BACKGROUND OF INVENTION

1. Field of the Invention

The present invention is directed to a method of analyzing and quantifying attorney's success rate, more particular with a graphical results page.

2. Background

There are a large number of lawsuits brought in the United States. Especially when dealing with personal injury and other torts. It is hard to know who to choose as a lawyer especially before certain judges and certain types of cases. It is difficult to know if you have the right one for the job without a lot of research and time.

There is still room for improvement in the art.

### SUMMARY OF THE INVENTION

The current invention is a system, method and program product that uses that uses historically case history and other information based on an attorney's success rate before a certain judge or court for certain types of cases to advise a client whether to keep the attorney or find another one for that case and/or jurisdiction. It is litigation analysis. It provides this information in an easy to read and understand graphic display.

Given the significant value of these types of cases the monies involved can be substantial.

### BRIEF DESCRIPTION OF THE DRAWINGS

Without restricting the full scope of this invention, the preferred form of this invention is illustrated in the following drawings:

FIG. 1 is a block diagram showing a basic arrangement of a computer system that can run the current invention; and

FIG. 2 is a schematic block diagram of a conceptualized operation of the present invention

FIG. 3 is an example of the graphic results.

### BRIEF DESCRIPTION OF THE PREFERRED EMBODIMENTS

There are a number of significant design features and improvements incorporated within the invention.

The current invention is a system 1, method and program product that uses past case history from how attorneys in various cases and before certain judges.

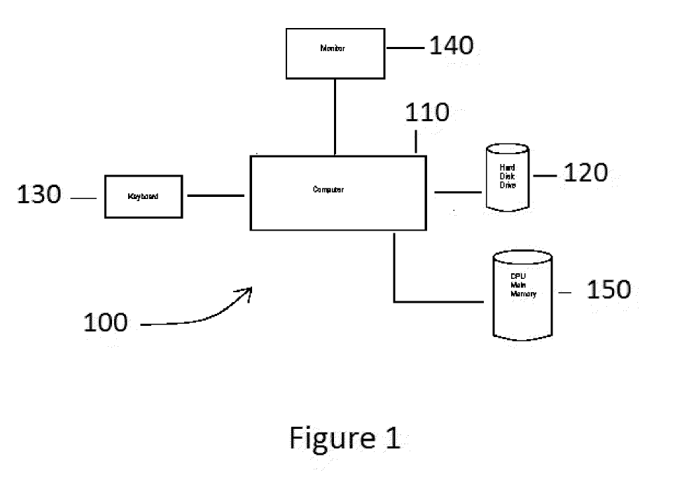

The system 1 can be set up to be run a on a computing device. FIG. 1 is a block diagram showing a computing device 100 on which the present invention can run comprising a CPU 110, Hard Disk Drive 120, Keyboard 130, Monitor 140, CPU Main Memory 150 and a portion of main memory where the program resides and executes. A printer can also be included. Any general purpose computer with an appropriate amount of storage space is suitable for this purpose. Computer Devices like this are well known in the art and is not pertinent to the invention.

The computer device 100 could be connected to other computer devices 100 through a communication interface such as the Internet, a wide area network (WAN), internetwork, telephone network or a private Value Added Network (VAN).

The storage and databases for the system may be implemented by a single data base structure at an appropriate site, or by a distributed data base structure that is distributed across an intra or an Internet network.

The files and file components discussed herein may be paper files, but in a preferred embodiment comprise data structures with electronic data. The setting up of the files and file structure is commonly known in the art and is not disclosed here.

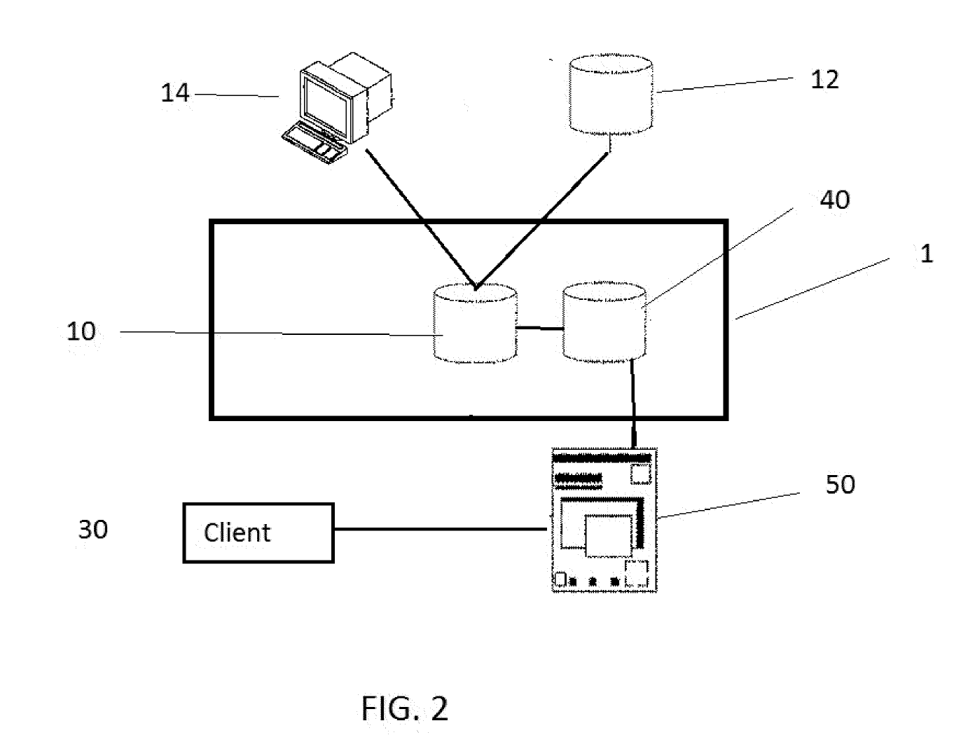

This system 1 is shown in FIG. 2, the System 1 will gather information 10 about court case results. These can be from certain judges or fields or jurisdictions or all threes. It can be limited to the fields of practice or jurisdictions or even down to actual before a particular judge.

The information 10 can be gathered from court databases 12 or keyed into the system 1 by a keyboard entry 14 or any other method of entry. The information 10 will have data on everything relevant available that can be used to analysis the litigation results. This data would include but not limited to the judge the case was heard, the type of case, the whether the case went to trail, the success of the attorney, the settlement received and whether the attorney represented the plaintiff or the defendant.

This data 40 can be specifically analyzed using a computer processing means for the client 30 depending on their needs or their specific case. The client 30 can be an individual, a small company, an attorney or even a large corporation.

The data 40 is loaded into electronic medium and is analyzed by the system 1 based on the desired criteria.

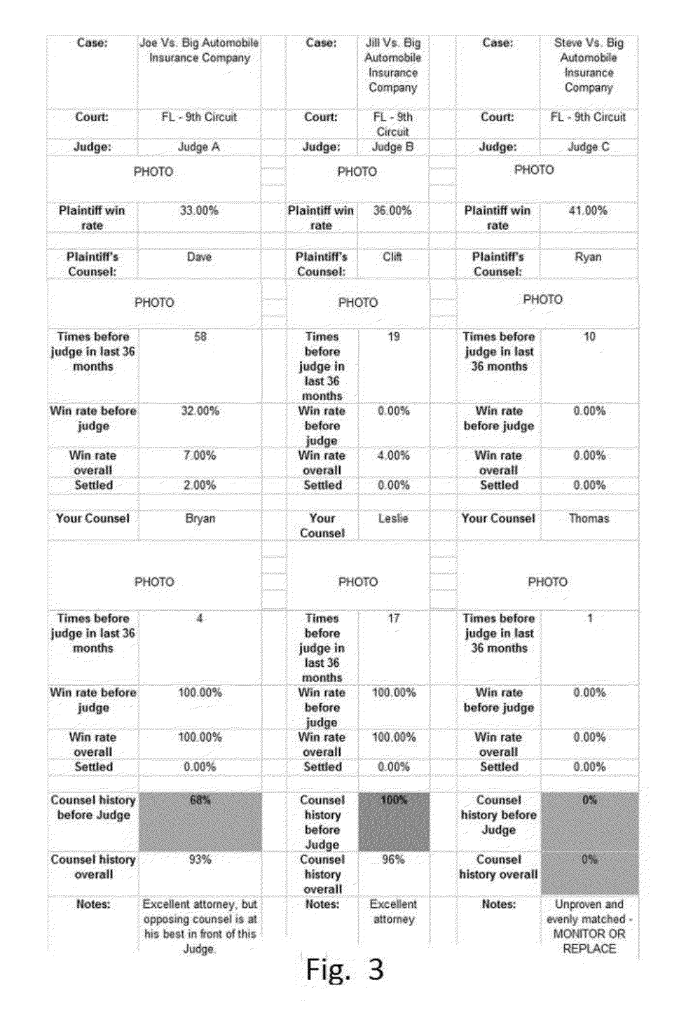

The system 1 will use the data 40 to produce an easy to read and understand results graph 50 as shown in FIG. 3.

The graph 50 will have the case or cases that the client is interested in. It will display the court such as the Florida 9^{th} circuit and the Judge as well as a picture of the Judge if available. It will display the Plaintiff attorney's win rate with a picture of the Attorney if available, the times the attorney was before the Judge within the last 36 months, the win rate before the judge, the win rate overall and percent settled. It will display the client's attorney with a photo if available, the times this attorney was before the Judge within the last 36 months, their win rate before the Judge, their overall win rate, their settlement percentage and their history overall. Finally there will be a note section in which the system 1 will advise the client about the case.

This graph 50 is for Defendant's attorney. The position of the Attorney information will flip if the client is the Plaintiff in the case.

The notes section of the graph 50 will have comments such as excellent attorney; attorney is successful but has not argued before this judge; unevenly matched, monitor or replace; or replace. These comments are based on the analysis of the case history before that judge or court. The system 1 can also give information about the judge and whether it is a plaintiff or defendant friendly judge.

It should be appreciated that many other similar configurations are within the abilities of one skilled in the art and all of these configurations could be used with the method of the present invention. Furthermore, it should be recognized that the computer system and network disclosed herein can be programmed and configured by one skilled in the art in a variety of different manners to implement the method steps described further herein.

### ADVANTAGES

The advantages of this to client are they know who to hire or watch when litigating a case before a certain court or judge. Given the size of many law suits the potential income is significant.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method comprising the steps: having a information about previous court cases, loading this information into a database stored on electric means, using this information to create data, using the data to create a graphical output about an attorney's success rate.

2. The method as defined in claim 1, wherein said success rate is based on cases before a certain judge.

3. The method as defined in claim 1, where said success rate is based on cases before a certain court.

4. The method as defined in claim 1, said success rate is based on cases on a certain type of cases.

5. The method as defined in claim 1, where said graph shows the attorney's success rate for the last 36 months.

6. The method as defined in claim 1, where said graph gives advice about the attorney.

7. The method as defined in claim 1, where said graph displays the attorney's win percentage.

8. The method as defined in claim 1, where said graph displays the opposing attorney's winning percentage.

9. The method as defined in claim 1, where said graph contains photographs.

10. A system comprising: information about court case results for a set period where the information is reviewed based on specific criteria and results are outputted in a graphic format.

11. The system as defined in claim 10 where the graphical output displays an attorney's success rate.

12. The system as defined in claim 11, wherein said success rate is based on cases before a certain judge.

13. The system as defined in claim 10, where said success rate is based on cases before a certain court.

14. The system as defined in claim 10, said success rate is based on cases on a certain type of cases.

15. The system as defined in claim 10, where said graph shows the attorney's success rate for the last 36 months.

16. The system as defined in claim 10, where said graph gives advice about the attorney.

17. The system as defined in claim 10, where said graph displays the attorney's win percentage.

18. The system as defined in claim 10, where said graph displays the opposing attorney's winning percentage.

19. The system as defined in claim 10, where said graph contains photographs
